(19) United States
(12) Patent Application Publication
(10) Pub. No.: US 2019/0305945 A1
(43) Pub. Date: Oct. 3, 2019

(54) METHOD FOR IMPLEMENTING A CRYPTOGRAPHIC FUNCTION FOR A SECRET KEY

(71) Applicant: IDEMIA IDENTITY & SECURITY FRANCE, Courbevoie (FR)

(72) Inventors: Cyril PORTERET, Courbevoie (FR); Christophe SOUMAH, Courbevoie (FR)

(21) Appl. No.: 16/368,740

(22) Filed: Mar. 28, 2019

(30) Foreign Application Priority Data
Mar. 29, 2018 (FR) 1852738

(51) Int. Cl. H04L 9/08

(52) U.S. Cl. CPC H04L 9/0877; H04L 9/0838

(57) ABSTRACT

The present invention relates to a method for implementing a cryptographic function for a secret key, the method being characterized in that it comprises the implementation, by data processing means (11) of an equipment (1), of steps consisting in:
(b) Constructing a unique sequence of cryptographic macro-instructions, representing said cryptographic function for said secret key, based on:
   a generic list of cryptographic macro-instructions executable by a given virtual machine; and
   an individual file of data describing said sequence;
(c) Executing, by said virtual machine, said unique sequence of cryptographic macro-instructions.

### GENERAL TECHNICAL FIELD

The present invention relates to the field of cryptography, and in particular a “white box” type cryptographic method.

### STATE OF THE ART

A function is considered as a “black box” when its internal functioning cannot be accessed, i.e. when its inputs and outputs can be known but not its secret parameters (keys) or its intermediate states.

The cryptographic algorithms (for example for encryption or signature) are thus conventionally assumed to be black boxes when their reliability (resistance to attacks) is evaluated.

This assumption imposes a strong constraint on the storage and the manipulation of these parameters. However, tools have been recently published to allow the automation of attacks on hardware implementation, called auxiliary channel or fault attacks.

Today, for many cases of use including mobile payment, it is necessary to deploy cryptographic algorithms with the least possible assumptions about the security of the target hardware. Secure storage and manipulation of secret parameters must then be assured at the application level.

The cryptography called white box cryptography aims at meeting this challenge by proposing implementations of the cryptographic algorithms that are supposed to make impossible the extraction of secrets, even in case of attack allowing the attacker full access to the software implementation of the algorithm. More precisely, a function is considered as a “white box” when its mechanisms are visible and make it possible to understand its functioning. In other words, it is directly assumed that the attacker has access to everything he/she wants (the binary is completely visible and modifiable by the attacker who then has full control of the execution platform). Consequently, the implementation itself is the only line of defense.

In order to protect the implementation of a cryptographic algorithm, a solution consists thus in merging the keys with the function using them by representing the calculations by tables. This avoids having the keys visible, they are said to be “whiteboxed”.

However, this solution proves to be incompatible with some operating systems (OS), in particular mobile ones, that allow the code loading only from official application platforms called “store” (for example the App Store for iOS), after validation of the code, and do not allow the loading or the subsequent code modification by intermediate users (for example a security software provider) or final users (the owner of the phone).

Indeed, the fact of whiteboxing a key implies that the code implementing the algorithm is different for each key, i.e. for each user.

It would then be required for the application platform of the OS to individually authorize each individual version of the application, which is not possible.

Alternatively, it would be required for the application platform to authorize the loading via the official platform of a common version of the application, in which a certified organization would insert an individual code block, but it is unlikely that the OS providers accept such a “breach” in the current process that provides that any line of code proposed at the loading is previously subject to validation and authorization by the OS provider.

It would therefore be desirable to have a new “white box” solution that remains compatible with the processes of making applications available on official, in particular mobile, OS platforms.

### PRESENTATION OF THE INVENTION

According to a first aspect, the present invention relates to a method for implementing a cryptographic function for a secret key, the method being characterized in that it comprises the implementation, by data processing means of an equipment, of steps consisting in:

(b) Constructing a unique sequence of cryptographic macro-instructions, representing said cryptographic function for said secret key, based on:
a generic list of cryptographic macro-instructions executable by a given virtual machine; and
an individual file of data describing said sequence;

(c) Executing, by said virtual machine, said unique sequence of cryptographic macro-instructions.

According to other advantageous and non-limiting features:
said individual file defines said unique sequence of cryptographic macro-instructions as a sequence of elements of said generic list of cryptographic macro-instructions;
said data describing said sequence successively identify each of the macro-instructions of said sequence in said generic list of cryptographic macro-instructions;
the individual file is uniquely associated with the secret key;
a prior step (a) of obtaining a generic application capable of implementing said virtual machine and including said generic list of cryptographic macro-instructions executable by the virtual machine, and of said individual file;
obtaining said individual file comprises the subsequent loading of the file by said application;
the generic application is loaded by the equipment from a first application platform server, and the individual file is loaded by the application from a second server holding the secret key;
the loading of the individual file comprises beforehand the sending of a request to the second server, the generation by the second server of the individual file from the secret key, and the reception of the individual file by the equipment.

According to a second aspect, there is proposed an equipment characterized in that it comprises data processing means configured to:
Construct a unique sequence of cryptographic macro-instructions, representing a cryptographic function for a secret key of a user of the equipment, based on:
   a generic list of cryptographic macro-instructions executable by a given virtual machine; and
   an individual file of data describing said sequence;
Execute, by said virtual machine, said unique sequence of cryptographic macro-instructions, so as to implement said cryptographic function for the secret key of the user.

According to a third and a fourth aspect, the invention proposes a computer program product comprising code instructions for executing a method according to the first aspect of implementation of a cryptographic function for a secret key; and a computer equipment readable storage means on which a computer program product comprises code instructions for executing a method according to the first aspect of implementation of a cryptographic function for a secret key.

### PRESENTATION OF THE FIGURES

Other features and advantages of the present invention will become apparent upon reading the following description of a preferred embodiment. This description will be given with reference to the appended drawings in which:

FIG. 1 is a diagram of an architecture for implementing the method according to the invention;

FIG. 2 illustrates an exemplary implementation of step (a) of an embodiment of the method according to the invention.

### DETAILED DESCRIPTION

Architecture

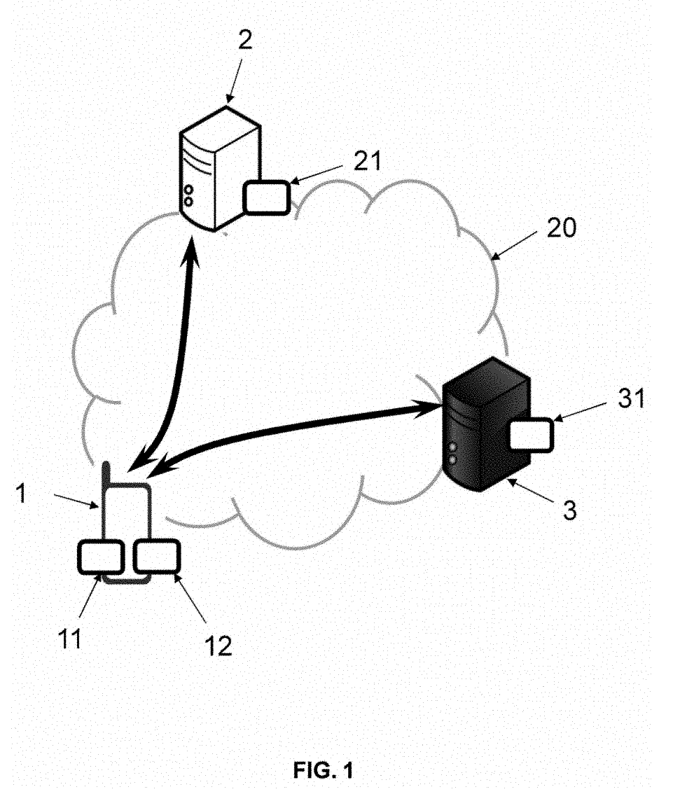

With reference to FIG. 1, there is proposed a method for implementing a “white box” cryptographic function implemented within an equipment 1 such as a mobile terminal (Smartphone, Touchpad, etc.), i.e. an equipment that does not particularly have a secure hardware and that can be the object of attacks on hardware implementation, and for which the white box approach becomes useful.

The equipment 1 comprises data processing means 11 (a processing unit such as a processor) and data storage means 12 (a memory, for example a flash memory).

The equipment 1 can be connected to a first server 2 and/or to a second server 3 for example via the Internet network 2. Each server 2, 3 can comprise data processing means 21, 31. The first server can be that of an application platform, in particular the official application platform associated with the operating system of the equipment 1 (for example that of the App Store if the equipment 1 is an iOS mobile terminal), and the second server can be that of a security solution provider.

As will be seen, in a preferred embodiment, the equipment 1 will be required to obtain, for the implementation of the present method, an application from the first server 2 and a data file from the second server 3.

The equipment 1 can itself be connected to other third party servers with which it can exchange for example messages obtained by means of the present method.

Cryptographic Function

The present method is a method for implementing a cryptographic function for an individual secret key (or an individual combination of secret keys), in particular the key of the equipment 1 user. Note that the second server 3 can hold the secret key (and generally the keys of a plurality of users).

The cryptographic function can be “encryption or decryption”, it means that it allows, where appropriate, encrypting or decrypting data.

Alternatively, the cryptographic function can be signature, that is to say, it allows the user to irrevocably sign a document.

The person skilled in the art will be able to apply the present method to any symmetrical or asymmetrical cryptographic function which involves a secret that should not be known outside the equipment 1.

It will be understood that the present method is a new implementation of known algorithms. More specifically, it does not propose a new cryptographic strategy, but only a new way of manipulating data within the algorithm that is resistant to all hardware attacks in “white box”. Thus the secret key of the user is “obfuscated” in the cryptographic function, that is to say, merged with the latter instead of being an input parameter (the cryptographic function is thus individualized) so that a third party having access to the memory 12 of the equipment 1 cannot read the clear key.

To rephrase, it will be understood that the term “obfuscation” here is meant within the context of white box cryptography, that is to say, specifically relates to the burial of secret keys so as to prevent their extraction by a third party who would have access to the environment, and should not be confused with the code obfuscation which is the fact of making “illegible or incomprehensible” some computer code to prevent reverse engineering in a general way, regardless of any cryptographic problem.

Thus, the goal is presently the whitened implementation of said cryptographic function for the secret key, i.e. the implementation obfuscating the secret key.

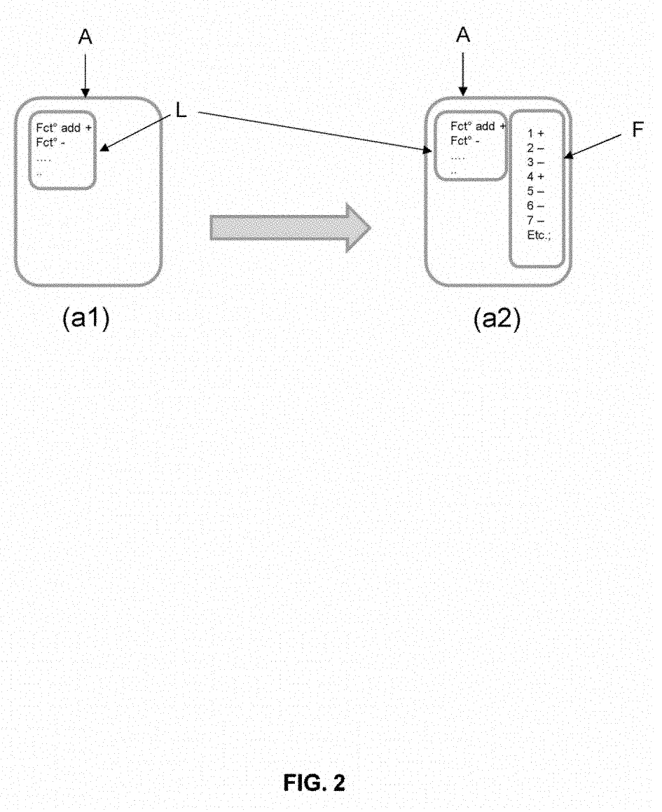

The present method is implemented by the equipment 1 data processing means 11. It achieves the feat of individualizing the cryptographic function while continuing to use the official application platforms. With reference to FIG. 2, the present method for this purpose combines two elements:
a generic list (noted L) of cryptographic macro-instructions executable by a given virtual machine, in particular contained by an application (noted A) which is also generic; and
an individual data file (noted F).

By “generic” is meant common to all users, as opposed to the individual file specific to the user.

As will be seen, the combination of these two elements through a virtual machine allows the construction of a unique sequence of cryptographic macro-instructions, representing said cryptographic function for said secret key, i.e. the individualized function. In other words, the unique sequence of cryptographic macro-instructions constitutes a whitened implementation of said cryptographic function for said secret key, i.e. obfuscates the secret key.

In an optional step (a), the two elements are obtained by the equipment 1. With reference to FIG. 2, obtaining the generic list is noted (a1), and obtaining the individual file is noted (a2).

It will be understood that this step (a) needs to be implemented only once, and then the rest of the method can be implemented whenever it is desired to implement the cryptographic function.

As explained, the list is preferably contained in a generic application capable of implementing the virtual machine (i.e. containing the code necessary for the execution of the virtual machine on the equipment 1 processing means 11). This application is common to all users and therefore can be proposed to the application platform (it can undergo a certification process) so as to be generically downloadable (i.e. by all users regardless of their secret key) from the server 2 implementing the platform.

The virtual machine allows “encapsulating” the cryptographic macro-instructions. More specifically, these are written in a language executable by the virtual machine but not executable by the data processing means 11 of the equipment (i.e. not a language recognized by the OS). The virtualization thus allows the execution of varied code in isolation from the OS, this is called “sandboxing”. This language executable by the virtual machine is preferably a low-level bytecode that includes code and data to perform every macro-instruction.

For its part, the virtual machine is advantageously the simplest possible to improve the performances, and in particular a pure algorithmic virtual machine.

This means that it does not allow any external functionality, i.e., no input/output, no driver, no network access, no file access, and absolutely no interaction with the operating system. However, it is of course possible that the virtual machine has access to the random access memory (RAM) to be able to work, but not to any other storage system. As such, a memory area can be (“hermetically”) reserved and blocked within the memory used by the application.

It is indeed important to understand that a VM that would “circumvent” the prohibition of loading unverified code by being able to control the functionalities of the terminal would be rejected and prohibited to make available on the official platform applications associated with the operating system of the equipment 1.

It is meant by cryptographic macro-instructions “elementary” cryptographic functions serving as components to express the “complex” cryptographic function that is object of the present method. It could be basic arithmetic functions, “look up”, calculation in tables, shift in one direction or the other, error detection, etc. i.e. the typical functions of the triple DES or AES type algorithms.

Thus, as will be seen, the individualized cryptographic function (for the secret key) will be expressed as a unique sequence of cryptographic macro-instructions of said list. Different sequences will make it possible to represent different versions of the cryptographic function, i.e. various values of the key.

The “list” of cryptographic macro-instructions contains the computer code of each possible macro-instruction, in the language of the virtual machine. This list can be seen as a kind of ontology describing an exhaustive collection of all usable macro-instructions. The macro-instructions can be uniquely identified in the list by a name or number.

In so far as the list contains code, it cannot be obtained otherwise than via the application platform of the server 2 if the OS provider imposes restrictions. However, since it is generic, it is not a problem.

Thus, a third party with knowledge of the list alone can do nothing with it because it only declares the macro-instructions and does not specify how to use them. The idea is that thanks to the list, the entire code to be executed for implementation is present in the application from the beginning, although the way this code must be executed is still unknown. Therefore, there is no need for code loading a posteriori, and the restrictions of the OS in terms of passage through the official platform are thus not contravened.

The “individual file” is in turn a descriptive data file of the unique sequence that represents the cryptographic function individualized by the key. Thus, it is only a data file, it does not comprise a code, and indeed avoids the need to be obtained from the application platform of the server 2, and can be recovered a posteriori, from the server 3 (as explained, typically a server of a security solution provider).

The individual file is associated with the individual key (and same function of that individual key), in so far as a file allows uniquely obtaining the version of the cryptographic function for a key. More precisely, the individual file is chosen such that, for a given key, a given cryptographic function and a given generic list of cryptographic macro-instructions, said unique sequence of cryptographic macro-instructions constructed for this individual file represents exactly the cryptographic function for that secret key. A different secret key will therefore result in a different individual file, and thus the individual file “represents” the secret key without containing it and therefore without the latter being accessible, hence the obfuscation.

It is therefore understood that each user has an individual file generated from his individual key (which is assumed to be given), so that the individual file is fully defined and is not a (voluntarily or arbitrarily) chosen object.

By “descriptive data of said sequence” is meant that said individual file defines said unique sequence of cryptographic macro-instructions as a sequence of elements of said generic list of cryptographic macro-instructions.

Advantageously, said data describing said sequence are instructions successively identifying each of the macro-instructions of said sequence in said generic list of cryptographic macro-instructions.

The individual file can be seen as an “interpreter” of the cryptographic micro-instructions in that it allows the generic list to be executed.

To rephrase again, the file only defines the choice and order of the macro-instructions in the list that compose the sequence. One again, the file does not contain any code (and a fortiori not the precise code of the macro-instructions) and therefore only identifies the macro-instructions, for example via their name or their number in the list. Thus, a malicious third party intercepting the file will not be able to do anything with it. And even if he/she had the list and file of a user (for example if he/she steals his equipment 1), he/she could at best implement the cryptographic function, but not find the secret key obfuscated in the unique sequence.

In the example of FIG. 2, there are two macro-instructions marked “+” and “−” defined in the list L, and the file F describes the following sequence “+, −, −, +, −, −, −”.

In other words, the unique executable sequence representing the individualized cryptographic function is as follows: once the code of the function +, twice the code of the function −, once the code of the function +, three times the code of the function −.

Preferably, the initialization step (a) is carried out in this way:
in the sub-step (a1), the user loads (in the memory 12) from the application platform of the server 2 the generic application capable of implementing said virtual machine and including said generic list of cryptographic macro-instructions executable by the virtual machine, the application is then installed on the equipment 1. Note that the user can do this through a dedicated application of the OS for access to said application platform, such as the iOS “App Store” application that allows access to the platform of the same name to launch an application download.
In sub-step (a2), the application is “customized” thanks to the loading (in the memory 12) of the individual file corresponding to his personal key, from the server 3. It is noted that there is longer passage through the official application platform. This loading can be for example initiated at the first launch of the still generic application. Preferably, step (a2) then comprises the prior sending of a request to the second server 3, the generation by the second server 3 (using its data processing means 31) of the individual file from the secret key, and the reception of the individual file by the equipment. As such, the server 3 can request the transmission from the equipment 1 of data proving the identity of the user, for example a recent photo with a camera of the equipment and a scanned identity document, before accepting to process the request.

The customized application then does indeed contain the obfuscated key, and it is operational to implement the cryptographic function.

In a step (b) in conventional operation, as explained, the data processing means 11 construct the unique sequence of cryptographic macro-instructions representing said cryptographic function for said secret key, based on:
the generic list of cryptographic macro-instructions executable by a given virtual machine; and
the individual file of data describing said sequence.

Finally, the method comprises a step (c) of executing, by said virtual machine, said unique sequence of cryptographic macro-instructions, so as to implement the cryptographic function for the secret key of the user.

Computer Program Product

According to a second aspect, the invention relates to an equipment 1 for implementing the method according to the first aspect, in particular of the mobile terminal type.

The equipment 1 thus comprises data processing means 11 configured to:
Construct a unique sequence of cryptographic macro-instructions, representing a cryptographic function for a secret key of a user of the equipment 1, based on:
   a generic list of cryptographic macro-instructions executable by a given virtual machine; and
   an individual file of data describing said sequence;
Execute, by said virtual machine, said unique sequence of cryptographic macro-instructions, so as to implement said cryptographic function for the secret key of the user.

Computer Program Product

According to a third aspect and a fourth aspect, the invention relates to a computer program product comprising code instructions for carrying out (in particular on the data processing means 11 of the equipment 1) a method according to the first aspect of the invention for implementing a cryptographic function for a secret key, as well as storage means readable by a computer equipment (a memory 12 of the equipment 1) on which this computer program product can be found.

1. A method for implementing a cryptographic function for a secret key, the method being characterized in that it comprises the implementation, by data processing means (11) of an equipment (1), of steps consisting in:
(b) Constructing a unique sequence of cryptographic macro-instructions, representing said cryptographic function for said secret key, based on:
a generic list of cryptographic macro-instructions executable by a given virtual machine; and
an individual file of data describing said sequence;
(c) Executing, by said virtual machine, said unique sequence of cryptographic macro-instructions.

2. The method according to claim 1, wherein said individual file defines said unique sequence of cryptographic macro-instructions as a sequence of elements of said generic list of cryptographic macro-instructions.

3. The method according to claim 2, wherein said data describing said sequence successively identify each of the macro-instructions of said sequence in said generic list of cryptographic macro-instructions.

4. The method according to any of claims 1 to 3, wherein the individual file is uniquely associated with the secret key.

5. The method according to claim 4, wherein the individual file is a function of the secret key.

6. The method according to any of claims 1 to 5, comprising a prior step (a) of obtaining a generic application capable of implementing said virtual machine and including said generic list of cryptographic macro-instructions executable by the virtual machine, and of said individual file.

7. The method according to claim 6, wherein obtaining said individual file comprises the subsequent loading of the file by said application.

8. The method according to claim 7, wherein the generic application is loaded by the equipment (1) from a first application platform server (2), and the individual file is loaded by the application from a second server (3) holding the secret key.

9. A method according to claims 5 and 8 in combination, wherein the loading of the individual file comprises beforehand the sending of a request to the second server (3), the generation by the second server (3) of the individual file from the secret key, and the reception of the individual file by the equipment (1).

10. An equipment (1) characterized in that it comprises data processing means (11) configured to:
Construct a unique sequence of cryptographic macro-instructions, representing a cryptographic function for a secret key of a user of the equipment (1), based on:
a generic list of cryptographic macro-instructions executable by a given virtual machine; and
an individual file of data describing said sequence;
Execute, by said virtual machine, said unique sequence of cryptographic macro-instructions, so as to implement said cryptographic function for the individual key of the user.

11. A computer program product comprising code instructions for the execution of a method according to any of claims 1 to 9 for implementing a cryptographic function for a secret key, when said program is executed by a computer.

12. A computer equipment readable storage means on which a computer program product comprises code instructions for the execution of a method according to any of claims 1 to 9 for implementing a cryptographic function for a secret key.
